(19) United States
(12) Patent Application Publication
(10) Pub. No.: US 2023/0158350 A1
(43) Pub. Date: May 25, 2023

(54) Protected Branch Connector Assembly For Fire Protection Systems

(71) Applicant: Minimax Viking Research & Development GmbH, Bad Oldesloe (DE)

(72) Inventors: Derek John SCHEFFERS, Mattawan, MI (US); Shawn J. FEENSTRA, Caledonia, MI (US)

(21) Appl. No.: 17/984,751

(22) Filed: Nov. 10, 2022

Related U.S. Application Data
(60) Provisional application No. 63/281,443, filed on Nov. 19, 2021.

(51) Int. Cl. A62C 35/68; A62C 31/02; A62C 31/28

(52) U.S. Cl. CPC A62C 35/68; A62C 31/02; A62C 31/28

(57) ABSTRACT

Device and methods of protecting a branch connector of a fluid supply pipe header for a fire protection system. A protected branch connector assembly includes a protective device that protects the branch connector fitting from dirt and debris and indicates that an internal seal member is in a desired seated orientation. The protective device includes a plug body inserted within the outlet opening of the branch connector fitting and an indicator in an indicative relationship with the branch connector to indicate that the internal seal member is in the desired seated orientation.

### PRIORITY DATA & INCORPORATION BY REFERENCE

This application claims the benefit of priority to U.S. Provisional Patent Application No. 63/281,443, filed on Nov. 19, 2021, which is incorporated by reference in its entirety.

### FIELD OF THE INVENTION

The present invention relates generally to protection devices for piping of fire protection systems. In particular, the present invention relates to a protective device for protecting a connection fitting to maintain the integrity of an internal seal.

### BACKGROUND OF THE INVENTION

Fire protection devices, such as, for example, sprinklers and/or nozzles, and systems that employ the fire protection devices are used, for example, in the protection of storage commodities and occupancies. Fire protection systems include a network of pipes connected to a firefighting fluid supply and installed in relation to the storage commodity or occupancy. The piping network includes one or more branch lines coupled to a cross-main which is connected to the firefighting fluid supply by a vertical piping riser to supply the branch line(s) with the firefighting fluid. The fire protection devices are connected to the branch lines in an appropriate orientation and at an appropriate spacing. To connect the fire protection devices to the branch lines, the branch lines are configured as linear pipe headers with branch connectors extending from the header for receipt and threaded connection of a fire protection sprinkler. Known connectors have one inlet end configured for connection to the pipe header and an opposite outlet end with a tapered threaded end for connection of a fire protection device. In order to form a fluid tight seal between the threadedly engaged connector and the fire protection device, a sealing tape or putty is applied to the thread of the fire protection device.

There are also known branch connectors which eliminate either or both of the tapered thread connection or the need to apply a sealing tape or putty. For example, each of U.S. Pat. Nos. 8,297,663 and 10,744,527, and U.S. Patent Publication No. 2019/0175968, show and describe connectors or adapters for connecting a fire protection device to a pipe header. Alternatively, PCT Patent Publication Number WO 2022/178179 shows and describes branch connectors for connecting a fire protection device in which the branch connectors are secured to a pipe header to provide a piping interconnection. Each of these known connectors use an internal straight thread at the outlet to connect the thread of the fire protection device, which allows the fire protection device to be placed in a desired rotational orientation without the interference of the thread engagement. Typically, the fire protection device includes a tapered thread; however, it may include a straight thread. To form a fluid tight seal between the connector and the fire protection device, each of the connectors employ an internal annular seal member. The fire protection device is then threaded into the connector and sufficiently torqued to form the fluid tight connection by compression of the internal annular sealing member. However, formation of the fluid tight seal between the connector and the fire protection device will be inhibited if the internal annular seal is omitted from the connector or improperly located within the connector, and/or the internal annular seal is damaged and/or covered with dirt and/or debris.

Thus, in order to form an effective fluid tight seal between the connector and the fire protection device, there is a need, prior to installation of the fire protection device, to have the capability to readily determine if the internal annular seal is properly located within the connector, to prevent damage to the internal annular seal, and/or to inhibit dirt and debris from entering the connector that could interfere with a sealing surface of the internal annular seal.

### SUMMARY OF THE INVENTION

Preferred embodiments of a preferred protective device provide a protected branch connector assembly for a supply pipe of a fire protection device, such as, a fire protection sprinkler and/or nozzle. The protected branch connector assembly includes a tubular member having a first terminal end surface defining an inlet opening, a second terminal end surface defining an outlet opening, and an internal passageway extending from the inlet opening to the outlet opening along a central longitudinal axis with an internal seal chamber. An annular seal member is disposed within the internal seal chamber and defines a seated orientation circumscribed about the central axis. The annular seal member has a first confronting surface confronting the inlet opening and a second confronting surface opposite the first confronting surface and confronting the outlet opening. A preferred protective device of the assembly includes a plug body having a first end and a second end coaxially spaced apart from one another along a central body axis. The plug body is coaxially inserted into the outlet opening of the tubular member with the second end, preferably, in surface contact with the second confronting surface of the seal member.

Preferred embodiments of the protected branch connector assembly locate the plug body, and, preferably the first end of the plug body as an indicator that defines at least one indicative relationship between the protective device and the tubular member to indicate that the annular seal member is within the internal chamber in the seated orientation. For example, the plug body of the protective device is configured such that when the plug body is inserted into the outlet opening of the tubular member, the first end of the plug body is aligned with, and preferably flush with, the second terminal end surface of the tubular body to provide at least one indicator that defines at least one indicative relationship between the protective device and the tubular member that indicates the annular seal member is within the internal seal chamber in the seated orientation. In addition, and/or alternatively, at least one indicator is preferably coupled, affixed or integrally formed with the first end of the plug body and axially spaced from the second terminal end surface of the tubular member to define a gap and spaced relationship therebetween that defines at least one indicative relationship between the protective device and the tubular member that indicates the annular seal member is within the internal chamber in the seated orientation. Alternatively, at least one indicator is preferably coupled, affixed or integrally formed with the first end of the plug body and is in contact and flush with the second terminal end surface of the tubular member to define at least one indicative relationship between the protective device and the tubular member that indicates the annular seal member is within the internal seal chamber in the seated orientation. Thus, the orientation of the first end of the plug body and the second terminal surface of the tubular body, and/or the gap or the contact between the at least one indicator and the second terminal end of the tubular member provides a readily discernably visual indicator that the annular seal member is within the internal seal chamber in the seated orientation.

A preferred method of protecting a fire protection pipe assembly includes, inserting a protective device into an outlet opening of a branch connector of the fire protection pipe assembly and indicating that an internal seal member is in a seated orientation within an internal seal chamber of the branch connector. The indicating is achieved by defining a dimensional relationship between the protective device and the branch connector. An alternate preferred method of protecting a fire protection pipe assembly includes, inserting a protective device into an outlet opening of a branch connector of the fire protection pipe assembly and indicating an internal seal member is missing from an internal seal chamber of the branch connector with an unretained engagement between the protective device and the branch connector. The indicating is also achieved by defining a dimensional relationship between the protective device and the branch connector.

A preferred protection device for use in the assembly and method includes a body with an insertion edge circumscribed about a central axis and a trailing edge circumscribed about the central axis. An indicator is preferably affixed, formed with or defined by the trailing edge. Preferred embodiments of the body include a base centered about the central axis defining the insertion edge with a peripheral wall circumscribed about the base and the central axis. The peripheral wall has an edge circumscribed about the central device axis defining the trailing edge that is spaced from the base to define an open end of the body.

### BRIEF DESCRIPTION OF DRAWINGS

The accompanying drawings, which are incorporated herein and constitute part of this specification, illustrate exemplary embodiments of the invention, and together, with the general description given above and the detailed description given below, serve to explain the features of the invention. It should be understood that the preferred embodiments are some examples of the invention as provided by the appended claims.

FIG. 1 is an illustrative exploded view of a fire protection device, such as, a sprinkler and/or a nozzle, installed in a preferred embodiment of a supply pipe header.

FIG. 2A is an illustrative exploded perspective view of one embodiment of a protected branch connector assembly having a first preferred embodiment of a protective device.

FIG. 2B is a perspective view of the protected branch connector assembly of FIG. 2A.

FIG. 2C is a cross-sectional view of the protected branch connector assembly of FIG. 2A.

FIG. 2D is an illustrative cross-sectional view of the protected branch connector assembly of FIG. 2A with the protective device being removed.

FIG. 3A is an illustrative cross-sectional view of the protected branch connector assembly of FIG. 2A with the protective device indicating a missing internal seal.

FIG. 3B is an illustrative cross-sectional view of the protected branch connector assembly of FIG. 2A with the protective device indicating the internal seal is not properly seated.

FIG. 4A is an illustrative exploded perspective view of one embodiment of a protected branch connector assembly having another preferred embodiment of a protective device.

FIG. 4B is a perspective view of the protected branch connector assembly of FIG. 4A.

FIG. 4C is a cross-sectional view of the protected branch connector assembly of FIG. 4A.

FIG. 4D is an illustrative cross-sectional view of the protected branch connector assembly of FIG. 4A with the protective device being removed.

FIG. 5A is an illustrative exploded perspective view of one embodiment of a protected branch connector assembly having yet another preferred embodiment of a protective device.

FIG. 5B is a perspective view of the protected branch connector assembly of FIG. 5A.

FIG. 5C is a cross-sectional view of the protected branch connector assembly of FIG. 5A.

FIG. 5D is an illustrative cross-sectional view of the protected branch connector assembly of FIG. 5A with the protective device being removed.

### DETAILED DESCRIPTION OF THE INVENTION

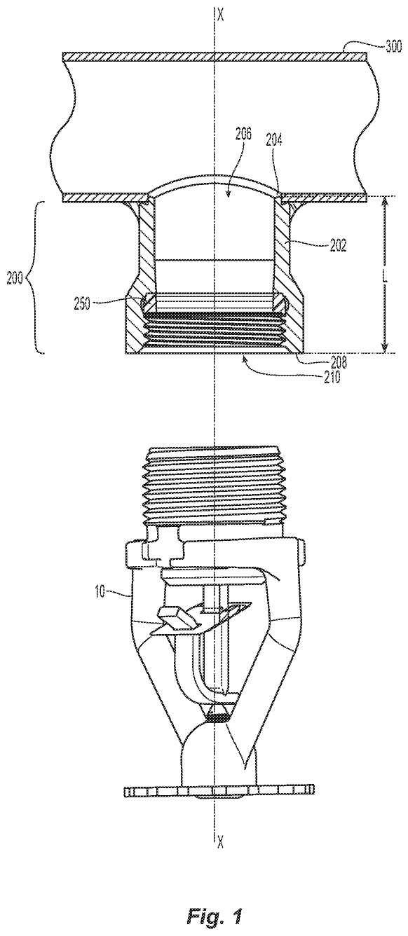

Shown in FIG. 1 is an exploded view of a fire protection device, for example, a fire protection sprinkler 10, for installation in an open preferred branch connector 200 of a fluid supply pipe header 300. Upon installation, the sprinkler 10 forms a fluid tight sealed connection with the branch connector 200. Firefighting fluid within the header 300 flows through the branch connector 200 to the fire protection sprinkler 10. The branch connector 200 generally includes a tubular member 202 having a first terminal end surface 204 defining an inlet opening 206 through which fluid flows from the fluid supply pipe of the header 300. Internally, the preferred branch connector 200 includes an annular seal member 250 that forms a fluid tight sealed engagement with the tubular housing of the branch connector 200 and the installed sprinkler 10. FIG. 1 shows a single branch connector 200 of the header 300, but it should be understood that the pipe header 300 can include an array of branch connectors 200, each with an internal seal member 250 for fluid tight engagement with a sprinkler 10. Further descriptions of the relationship of the fire protection sprinkler 10, the branch connector 200, and the fluid supply header 300 are provided in PCT Patent Publication Number WO 2022/178179, which hereby incorporated by reference in its entirety.

In order to protect the branch connector(s) 200 and maintain the integrity of the seal 250 prior to installation of the sprinkler 10, a preferred embodiment of a protective device is inserted into the outlet opening of the branch connector 200. Installed, preferred embodiments of the protective device protect the header 300, branch connector 200 and/or seal member 250 by closing off the outlet opening of the branch connector and minimizing its exposure to dirt and debris during storage, transport, or installation of the pipe header 300 and/or when awaiting installation of a sprinkler 10. In particular, the protective device inhibits damage to the seal member 250 and, moreover, preferred embodiments of the protective device provide or define one or more visual indicators to indicate that the annular seal member 250 is installed within the branch connector and more preferably indicate that the seal member 250 is properly installed and oriented in the branch connector 200. Additionally, preferred embodiments of the protective device are configured to be removed, preferably by hand or hand tool, to expose the outlet opening of the branch connector 200 for receipt of a fire protection sprinkler 10.

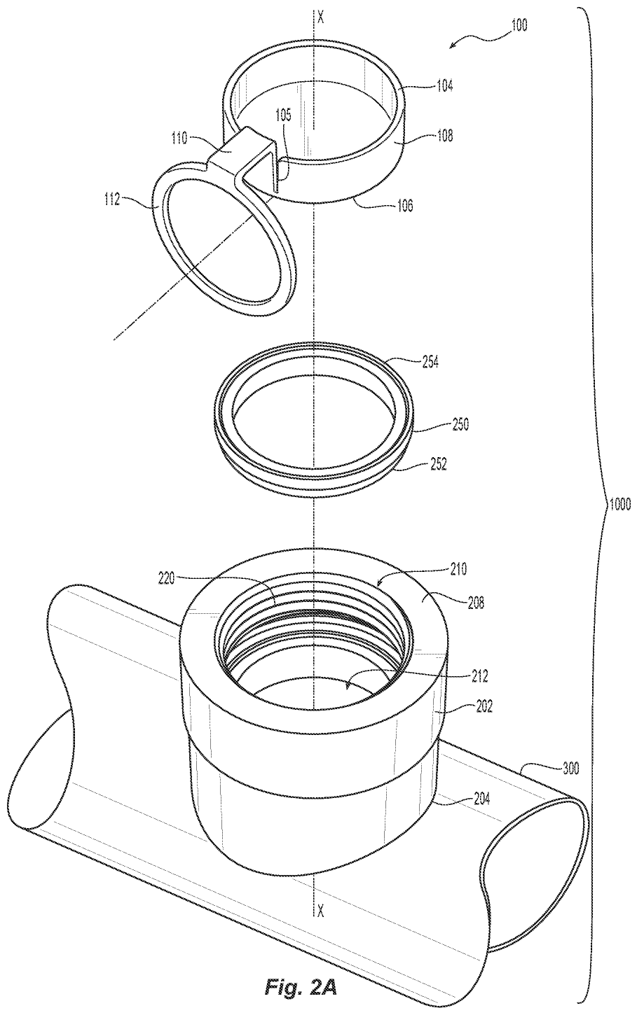

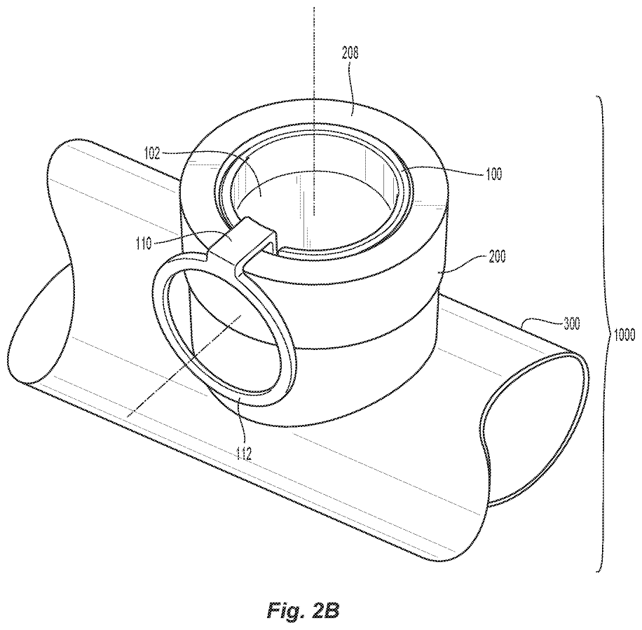

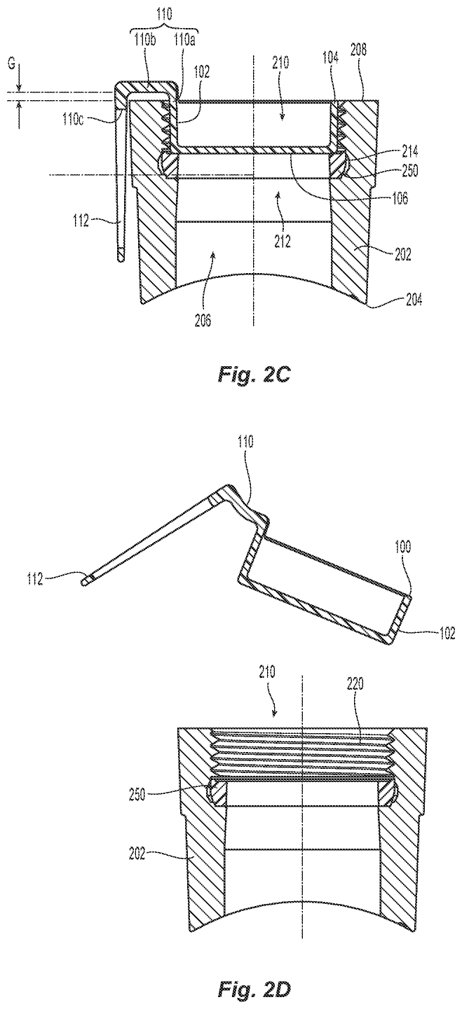

Shown in FIGS. 2A-2C is one embodiment of a protected branch connector assembly 1000 with a first preferred embodiment of a protective device 100 installed in a branch connector 200 connected to a pipe header 300. The branch connector 200 includes a second terminal end surface 208 defining an outlet opening 210 for temporary receipt of the protective device 100; and in a sprinkler system installation, for receipt of the sprinkler 10. The second terminal end surface 208 is preferably axially spaced from the first terminal end surface 204 to define an internal passageway or conduit 212 of the tubular member extending from the inlet opening 206 to the outlet opening 210 along a central longitudinal axis X-X. Formed along the internal passageway 212 of the branch connector 200 is an internal seal chamber 214 formed between the inlet and outlet openings 206, 210 for housing the internal seal member 250. Although the branch connector 200 and tubular member 202 is shown as a linear fitting it should be understood that the tubular member 202 could be formed as an elbow or formed as a tee-fitting provided the outlet opening 210 and internal seal chamber 214 are coaxially aligned for receipt of preferred embodiments of a protective device in a manner as described herein.

With specific reference to FIG. 2A, one manner of preferred forming the protected assembly 1000 includes connecting the branch connector 200 to the fluid pipe header 300. The first terminal end 204 of the tubular member 202 is preferably saddle-shaped for a welded connection to the pipe header 300. With the tubular member 202 connected, the annular seal member 250 is inserted and disposed within the internal seal chamber 214. The seal member 250 includes a first confronting surface 252 and a second confronting surface 254 axially spaced along the preferably central seal axis opposite one another about the annular seal member 250. When properly installed, the seal member 250 preferably defines a preferred seated orientation circumscribed about the central axis X-X with the seal axis parallel and preferably coaxially aligned with the central axis of the branch connector 200. Moreover, in the preferred seated orientation, the first confronting surface 252 confronts the inlet opening 204 and the second confronting surface 254 confronts the outlet opening 210.

The preferred protective device 100 is then subsequently inserted into the outlet opening 210. The device 100 forms a preferred frictional fit therein to remain within the opening 210 and the internal conduit 212 to prevent dirt or debris from entering the tubular member 202 of the branch connector 200. The frictional fit sufficiently retains and secures the device 100 within the outlet opening 210 against dislodgement from vibration or inadvertent impact. Moreover, the frictional fit preferably can be overcome by manually leveraging, pulling or prying the device 100 from the outlet 210 by hand or hand tool. In one preferred aspect, the outer surface of the inserted portion of the device is preferably 0.010-0.015 inch greater that the internal dimension of the outlet opening 210 provided by the internal threads 220 to form the desired frictional fit.

Once inserted, the preferred protective device 100 defines one or more dimensional relationships with the branch connector 200 to provide one or more indicators as to whether or not the seal member 250 is installed and/or properly in a seated orientation. The device 100 is preferably formed from a polymer or plastic material such as, for example, polyethylene and formed by molding such as, for example, injection molding. Preferred embodiments of the device 100 include a plug body 102 having a first end 104 and a second end 106 coaxially spaced apart from one another along a central body axis. The plug body 102 is the portion of the device 100 coaxially inserted into the outlet opening 210 of the tubular member 202 with the second end 106 of the body 102 coming into surface contact engagement with the seal member 250. In preferred embodiments of the assembly 1000, the second end of the body 106 is brought into surface contact engagement with the second confronting surface 254 of the seal member 250. With the second end 106 in surface contact engagement with the seal member 250, the first end 104 of the plug body 102 is preferably flush with the outlet opening 210 of the tubular member 202 to define one preferred indicative relationship between the device 100 and the tubular member 202 indicating that the annular seal member 250 is within the internal chamber 214 in the desired seated orientation.

Alternatively to forming a frictional fit between the tubular member 202 and the protective device 100, an alternate embodiment of the assembly 1000 retains the protective device 100 within the tubular member 202 by the surface contact engagement between the second end 106 of the plug body 102 of the device 100 and the seal member 250. More particularly, the second end 106 of the plug body 102 forms a surface engagement contact with an inner surface of the annular seal member 250 between the confronting surfaces 252, 254, that is sufficient to retain and secure the protective device 100 within the tubular member 202 of the branch connector 200. In order to provide the surface engagement, the peripheral wall 108 is sized to be located within the seal member 250. The peripheral wall 108 is preferably a member with a uniform width so that the second end 106 of the plug body 102 is sized to engage one or more of the surfaces of the seal member 250. Alternatively, the peripheral wall 108 is provided with a varying width sized to engage one or more of the surfaces of the seal member 250. For example, the second end 106 of the plug body 102 has a width that is less than a width of the first end 104 of the plug body 102, and the peripheral wall 108 has one or more transition surfaces, preferably, perpendicular to the axis of the plug body 102, between the first end 104 and the second end 106. When the second end 106 of the plug body engages one or more surfaces of the seal member 250, the one or more transition surfaces can contact or be spaced from surfaces of the seal member 250. Additionally, the second end 104 of the plug body 102 can also have a configuration, such as, projections, prongs, barbs, and/or hooks, to enhance gription of the seal member 250. Thus, failure to retain the device 100 within the tubular member 202 preferably indicates the absence of the seal member 250 within the tubular member 202. Accordingly, if the assembly was oriented such that the protective device 100 releasably falls out of the tubular member under the force of gravity, such an occurrence could indicate the absence of the required annular seal member 250. To facilitate release of the protective device 100 and its indicative relationship with the tubular member 202, the body 102 would be preferably sized so as to be radially spaced inward of the inner conduit 212 of the tubular member 202.

The plug body 102 is preferably formed as a cup in which the second end 106 is a preferably closed or solid planar surface for blocking the internal conduit 212 of the branch connector 200 from dirt or debris. The first end 104 of the plug body 102 is preferably open ended centered about the device axis and axially spaced from the second end 106. In the preferred cup configuration of the plug body 102, a peripheral wall 108 extends between the ends 104, 106 and circumscribes the device axis. As described herein, the preferred embodiments of the protective device 100 are preferably removable from the branch connector 200 by hand or hand tool. The plug body 102 of the protective device can include a slit 105 as seen in the device 100 to provide some pliability or relief in installing or removing the plug body 102 from the outlet opening 210 of the tubular member 202. The slit 105 can also facilitate formation of the protective device 100 by providing a relief to assist removal from a mold when the device 100 is formed from a polymer or plastic material.

Additionally, the device 100 includes at least one indicator 110, and more preferably more than one indicator 110, coupled, affixed to or formed with the first end 104. In the preferred connector branch connector assembly 1000 shown, the indicator 110 of the inserted device 100 is axially spaced from the second terminal end surface 208 of the tubular member 202 to define a gap G therebetween, as seen in FIG. 2C, that is an indicative relationship between the indicator 110 and the tubular member 202 of the branch connector 200 to indicate that the internal annular seal member 250 is within the tubular member 202 and in the preferred seated orientation within the internal chamber 214. The gap G is a visible gap, so that an installer of the protective device 100 can visibly confirm that the protected branch connector 1000 is assembled with the required seal member 250.

In another preferred aspect, the device 100 provides at least two-dimensional relationships between the protective device 100 and the tubular member 202 to indicate that the seal member 250 is in the desired seated orientation. Preferred embodiments of the protective device 100 includes the insertable plug body 102 in which the second end 106 defines an insertion edge circumscribed about the central device axis with the first end 104 defining a trailing edge circumscribed about the central axis with an indicator 110 affixed to and axially spaced from the trailing edge 104. Accordingly, in preferred embodiments of the device 100, the indicator 110 is formed axially spaced from the first end or trailing edge 104 of the plug body 102 by a distance preferably equal to the gap distance G. Thus, in the preferred protected assembly 1000 with the indicator 110 axially spaced from the second terminal end surface 208, the first end or trailing edge 104 of the plug body 102 is preferably flush with the outlet opening 210 of the tubular member 202 to define a second preferred indicative relationship between the indicator 110 and the tubular member 202 indicating that the annular seal member 250 is within the internal chamber 214 in the desired seated orientation. Accordingly, in one preferred aspect of the protective device 100, the plug body 102 has an axial distance between the first end 104 and the second end 106 that is preferably equal to the axial distance between the outlet opening 210 and the second confronting surface 254 of the seal member 250. The internal chamber 214 is preferably formed at the end of the internal thread 220 formed along the internal conduit 212 proximate the outlet opening 210. Therefore, in another preferred aspect of the plug body 102, the axial distance between the first end 104 and the second end 106 is preferably equal to the axial length of the internal thread 220 of the tubular member 202. Moreover, the width or diameter of the plug body 102 is preferably 0.010-0.015 inch greater the internal diameter of the thread dimension of the outlet opening 210 to form the desired frictional fit.

Shown in FIG. 2C is a cross-sectional view of the protected assembly 1000 in which the one indicator 110 of the protective device 100 includes a first portion or segment 110a extending axially from the first end 104 of the plug body 102 parallel to the peripheral wall 108 and central axis of the plug body 102. The preferred indicator 110 also includes a second portion or segment 110b that preferably extends orthogonally with respect to the first portion 110a of the indicator and radially outward with respect to the plug body axis and over the second terminal end surface 208 of the tubular member 200. In the preferred protected assembly 1000 shown, the gap G is defined between the second portion 110b of the indicator 110 and the second end terminal end surface 208 of the tubular member 202. Combined with the first end 104 of the plug body 102, which is open-ended, flush with the outlet opening 210, the second portion 110b indicates that the seal member 250 is in the seated orientation.

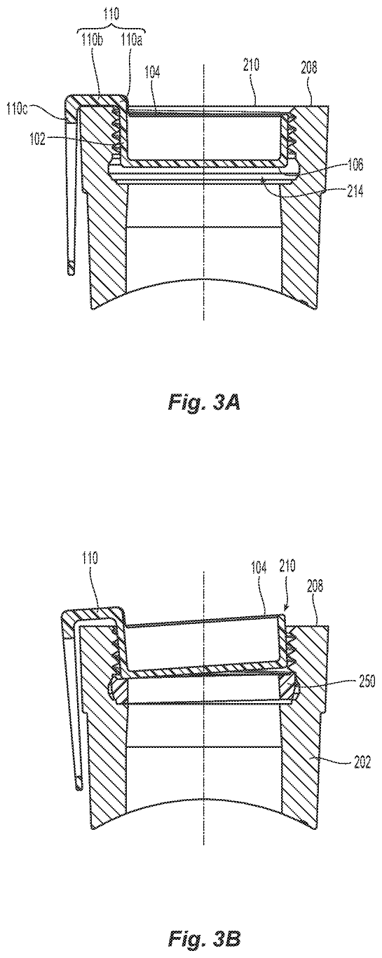

Referring now to FIGS. 3A-3B, the device 100 is illustratively shown that the seal member is not within the seated orientation. More particularly, the second portion 110b of the indicator 110 in FIG. 3A is shown in surface contact with the second terminal end surface 208 of the tubular member 202 to indicate that the seal member 250 is missing from the assembly. In FIG. 3B, the trailing edge 104 of the preferred open-ended plug body 102 is out of plane with the outlet opening 210 of the tubular member to indicate that the seal member 250 is not properly seated within the internal chamber 214 of the tubular member 202.

In alternate embodiments of the assembly 1000 in which the radially extending segment forming the indicator 110 extends directly from the plug body 102, for example from the first end 104 of the body 102, the radially extending segment of the indicator 110 can come into contact with the tubular end surface 208. Such an indicator 110 in combination with the first end 104 flush with the outlet opening 210, could provide for an alternate indicative relationship indicating that the seal member 250 is in the proper seated orientation.

In all preferred embodiments of the protected assembly 1000 described herein, the protective device 100 is removable, preferably by hand, to expose the outlet opening 210 for receipt of a fire protection sprinkler 10. In preferred embodiments of the device 100, the indicator 110 provides for a lever that can be used to pull the protected device out of the tubular member 202. With reference again to FIG. 2C, another preferred aspect of the protected assembly 1000, the indicator 110 includes a third portion 110c extending orthogonally from the second portion 110b in a direction parallel to the central device axis from the first end 104 toward the second end 106 of the protective device 100. In the device 100, the first and second portions 110a, 110b of the indicator 110 preferably forms a hinge connection between the third portion 110c and the plug body 102 to define a preferred lever for removal of the protective device 100 from the tubular member 202 as illustrated in FIG. 2D. In one preferred embodiment of the device 100, the third portion 110c can include or be formed with an annular ring 112. With reference again to FIGS. 2A and 2B, in the protected branch connector assembly 1000, the annular ring 112 has a central axis that preferably extends perpendicular to the central axis X-X when the second end 106 of the plug body 102 is inserted in the tubular member 202 and in surface contact with the second confronting surface 254 of the seal member 250.

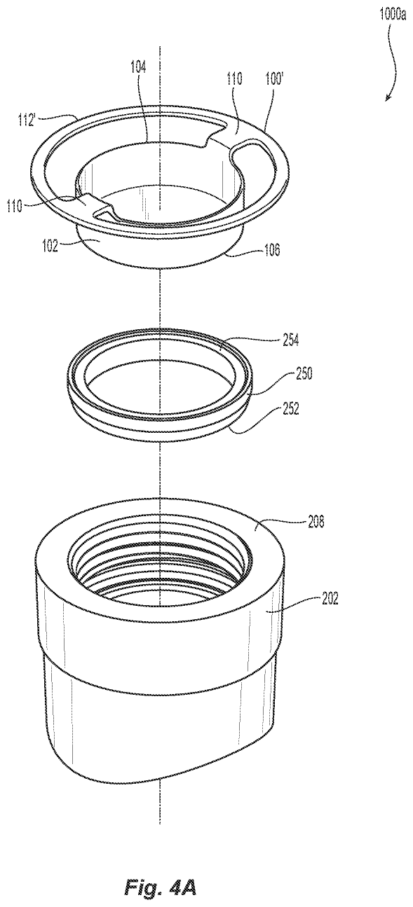

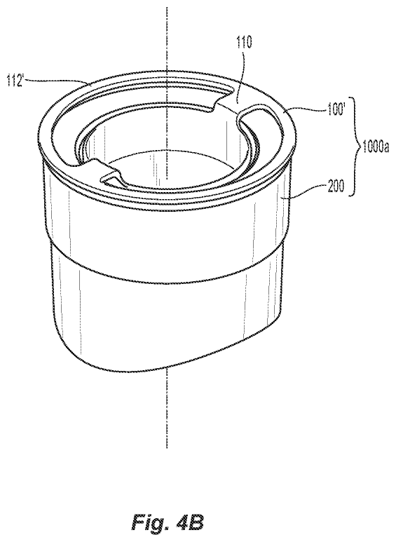

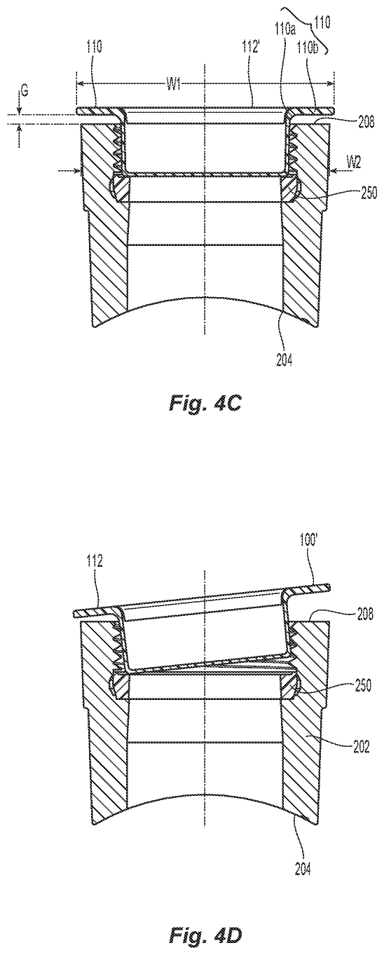

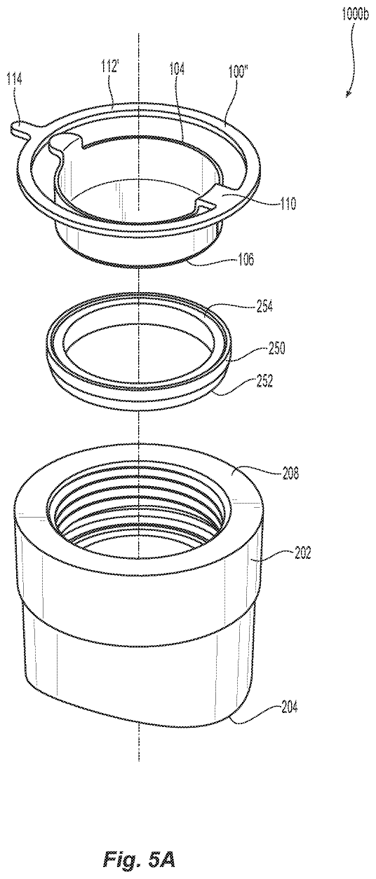

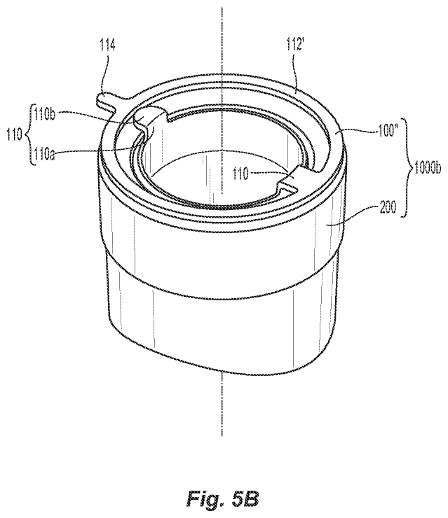

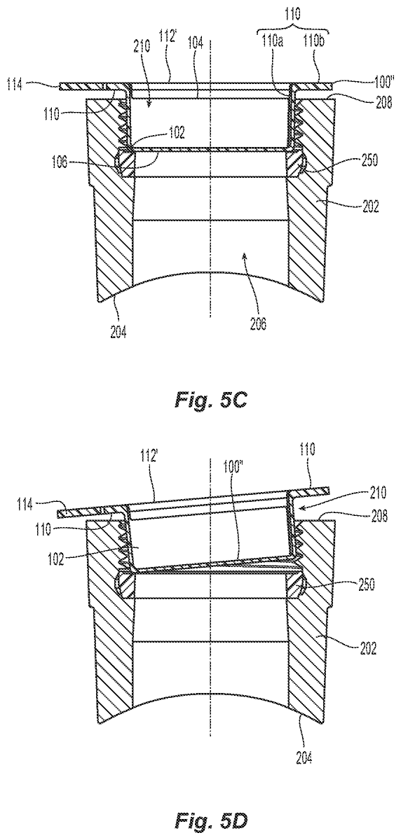

In the assembly 1000 of FIGS. 2A-2D, the protective device 100 includes a single indicator 110. In alternate embodiments of the protected assembly 1000a, 1000b, as shown for example in FIGS. 4A-4D and 5A-5D without the pipe header 300 for simplification, the protection device 100′, 100″ includes more than one indicator 110. More preferably as shown, the protective devices 100′, 100″ preferably includes a pair of indicators 110 diametrically opposed from one another about the plug body 102. Each of the indicators 110 preferably includes the first axially extending portion or segment 110a and the radially extending portion or segment 110b. Alternatively, the indicators can be formed by radially extending segments 110b that extend from the plug body 102 preferably at the first end 104. The protective device again preferably includes an annular ring portion 112′ that is affixed to one or both of the indicators. However, in these preferred embodiments of the protective device 100′, 100″, the annular ring 112′ circumscribes the central device axis and in the assembly 1000a, 1000b, the annular ring 112′ circumscribes the central longitudinal axis X-X. With the ring 112′ integrally formed with the second portion 110b of one or both of the indicators 110, the ring 112′ can also be spaced from the second terminal end surface 208 to define the preferred gap G in the assembly 1000a and provide visual verification that the seal member 250 is in the desired seated orientation within the tubular member 202. Alternatively, in the protected assembly 1000, the device 100, and, in particular, the plug body 102 can be configured so that when it is inserted in the tubular member 202 and is retained by the internal thread 220 of the tubular member 202 and/or the seal member 250, the ring 112′ comes into contact with the second terminal end surface 208 to provide an alternative visual verification that the seal member 250 is in the desired seated orientation within the tubular member 202.

With specific reference to FIGS. 4A-4D, the annular ring 112′ is not only an indicator for the seal member 250, the ring 112′ also preferably provides an element, edge or lip of the device 100′ that can be grasped by a sprinkler installer to remove the protective device 100′ from the branch connector 200 to expose the outlet opening 210 for installation of a sprinkler 10 as illustrated in FIG. 4D. Because the annular ring 112′ is, preferably, spaced from the second terminal end face 208 of the tubular member, the gap G can provide sufficient space in which a user can preferably insert their fingers or alternatively a tool to pry the protective cap 100′ from the branch connector 200. As shown in FIG. 4C, the annular ring 112′ defines a width W1 or diameter that is equal to the width W2 defined by the second terminal end face 208. In an alternate embodiment, the width of the annular ring 112′ of the device 100′ can be greater than the width W2 of the second terminal end 208 to provide an enhanced gripping surface of the device 100′ which a user can use to remove the protective device 100′ from the outlet opening 210 of the branch connector 200 for installation of a sprinkler 10.

Referring now to the protected assembly 1000b shown in FIGS. 5A-5D, the annular ring 112′ is affixed to only one indicator 110 of the two diametrically opposed indicators 110. As with the previously described embodiment of the protected assembly, each of the indicators 110 and the annular ring portion 112′ are axially spaced from the second terminal end surface 208 of the tubular member 202 to define the gap G indicative of the internal seal member 250 being in the desired seated orientation. The annular ring 112′ preferably includes a peripheral radially extending tab 114 which can be used as a lever to lift or pry the protective device 100″ out of the outlet opening 210 and remove it from the branch connector 200. The peripheral lever 114 is preferably aligned with each of the diametrically opposed indicators 110a, 110b. Moreover, the tab 114 is preferably diametrically opposed the one connection or integration between the annular ring 112′ and the one indicator 110. As seen in FIG. 5D, the tab 114 can be depressed to pry the plug body 102 out of the tubular member 202 of the branch connector 200. Alternatively, or additionally, the peripheral tab 114 can be used as a pull tab to pull the device out of the outlet opening 210 of the branch connector 200.

It should be understood that the varying features of the protective devices 100, 100′, 100″ can be alternatively applied or implemented in the other embodiments. Moreover, depending upon the configuration of the sprinkler 10 to be used in the system installation, the header 300 is installed to orient the branch connectors 200 for appropriate receipt of a pendent, upright or a sidewall/horizontal sprinkler 10. In a sprinkler system installation, firefighting fluid fed into the inlet opening 206 flows through the annular seal member 250 out the outlet opening 210 to supply the installed sprinkler 10 for discharge and distribution in accordance with the performance specification of the sprinkler 10.

The internal seal member 250 is illustratively shown with its confronting surfaces 252, 254. The annular seal member 250 is preferably configured as the seal shown in U.S. Pat. No. 10,744,527 and PCT Publication Number WO 2022/178179, each of which hereby incorporated by reference in its entirety, to provide a preferred leak-proof connection between the fire protection sprinkler 10 or an other fire protection device and the branch connector 200. Also, the branch connector 200 can be formed of any suitable material, such as, for example, metal, plastic, and/or combinations thereof. A preferred material for the seal member 250 is an EPDM material having a durometer hardness from 65 to 80, and preferably 70, to provide the desired sealing function and maintain sprinkler position. However, it should be understood that alternative configurations of the internal seal member can be provided and/or alternative configurations of the internal conduit of the branch connector can be provided, such as, shown and described, for example, in U.S. Pat. Nos. 8,297,663 and 10,744,527 and U.S. Patent Publication No. 2019/0175968, each of which are hereby incorporated by referenced in its entity, that can be utilized in the protected branch assembles and the methods of the preferred embodiments.

The length of the branch connector 200 is preferably defined between the second terminal end face 208 and a mid-point of the concave portion of the first terminal end surface 204. The overall length L of the branch connector 200 preferably ranges from 1 inch to 1½ inch. Moreover, the overall length L of the branch connector 200 preferably corresponds or varies with the outlet nominal diameter size. For example, for a nominal outlet diameter of 1 inch, the length L is preferably 1¼ inch, where the nominal outlet diameter is ¾ inch, the length L is preferably 1⅛ inch and where the nominal outlet diameter is ½ inch, the length L is preferably 1 1/16 inch.

In preferred embodiments of the branch connector 200, the portion of the branch connector having the internal threads 220 provides an internally threaded portion proximate the outlet opening 210 is preferably configured for coupling the sprinkler 10 by hand. The internally threaded portion is preferably configured for connection with a sprinkler 10 of a nominal size. Accordingly, preferred embodiments of the branch connector 200 at the outlet opening 210 define a nominal size or diameter ranging from ½ inch to 1½ inch and more particularly any one of ½ inch, ¾ inch, 1 inch, 1¼ inch or 1½ inch. Moreover, the external thread of a fire protection sprinkler is typically of a tapered form, for example, NPT thread, for threaded connection to the branch connector 200. Use of the preferred straight internal threads permits preferred embodiments of the sprinkler 10 to be rotatable about the axis X-X within the branch connector 200, preferably by hand, in any desired position while forming a proper fluid tight seal. The internally threaded portion of the tubular member 202 preferably includes an internal straight thread for receipt of the tapered sprinkler thread of the sprinkler 10. The internal diameter ID of the internal straight thread can be defined by any one of the pitch diameter, minor diameter or major diameter of the internal thread provided the straight thread engages the tapered thread of the sprinkler 20. The internal straight threads can be for example, a 1-11.5 NPSH Thread; a ¾-14 NPSH Thread; or a ½-14 NPS Thread for mating with a correspondingly nominal 1 inch, ¾ inch or ½ inch fire protection sprinkler.

Fire protection sprinklers include a sprinkler frame body with an inlet connected to a pressurized supply of firefighting fluid, such as water, and some type of fluid deflection member spaced from an outlet of the frame body to distribute firefighting fluid discharged from the outlet in a defined spray distribution pattern over an area to be protected. In some fire protection sprinklers, the release of fluid discharge from the sprinkler body is controlled. For example, automatic fire protection sprinklers include a fusible or thermally responsive trigger assembly which secures a seal assembly over an internal central orifice formed proximate the outlet of the frame body. When the temperature surrounding the automatic sprinkler is elevated to a pre-selected value indicative of a fire, the trigger assembly operates, fractures or collapses to release the seal assembly and fluid flow is initiated through the sprinkler body and out the outlet to impact the fluid deflection member. In contrast to the passive operation of the fusible or thermally responsive trigger assembly and seal assembly of an automatic fire protection sprinkler, other types of fire protection sprinklers have a controlled operation trigger assembly and seal assembly. For example, in such controlled operations, the trigger assembly and seal assembly are actuated in response to a control signal, and, in such actuated sprinklers, the trigger assembly and/or seal assembly is operated or otherwise ejected by a mechanical, electrical or computer-controlled actuator. In addition to the automatic or controlled operation fire protection sprinklers, any suitable threaded fire protection device that distributes a fire protection fluid can be utilized in the preferred embodiments of the protected branch connector assembly 1000.

The sprinkler 10 shown in FIG. 1 is illustratively shown generally including a frame with a body and a pair of frame arms disposed about and extending from the body and spaced apart from one another in a plane. A fluid deflection member is coupled to the frame arms and axially spaced from the body. The fluid deflection member and the sprinkler can be configured for installation as a pendent sprinkler, a horizontal sprinkler or an upright sprinkler. The sprinkler 10 is shown as an automatic sprinkler with a thermally responsive trigger assembly coaxially disposed between the body and the fluid deflection member. The trigger assembly is illustratively shown as a solder link and lever arrangement, but alternatively can be configured as a frangible glass bulb. The automatic fire protection sprinkler includes an internal seal assembly that is supported in place by the thermally responsive trigger assembly to maintain a fluid tight seal. Alternatively, or additionally, the trigger assembly and/or seal assembly can incorporate an actuator for a controlled discharge. As shown, the fluid deflection member of the sprinkler 10 is affixed to an apex coaxially aligned along the central sprinkler axis. The thermally responsive trigger assembly is preferably axially supported by a threaded load screw or member threaded into the apex. The discharge or flow characteristics from the sprinkler body is defined by the internal geometry of the sprinkler including its internal passageway, inlet and outlet (the orifice). Generally, the size of the sprinkler discharge orifice is defined by the nominal K-factor of a sprinkler. For a given sprinkler assembly, the larger the K-factor, the larger the discharge orifice, and the smaller the K-factor, the smaller the discharge orifice. Nominal K-factors for sprinklers listed in the National Fire Protection Association Standard Publication, NFPA 13: Standard for the Installation of Sprinkler Systems, can range from 1 to 30 [GPM/(psi.)^{1/2}] and greater. NFPA 13 identifies the following nominal K-factors of 14 or greater: 14[GPM/(psi.)^{1/2}] (“K14”); 16.8[GPM/(psi.)^{1/2}] (“K16.8”); 19.6[GPM/(psi.)^{1/2}] (“K19.6”); 22.4[GPM/(psi.)^{1/2}] (“K22.4”); 25.2[GPM/(psi.)^{1/2}] (“K25.2”) and 28.0[GPM/(psi.)^{1/2}] (“K28”). Even larger nominal K-factors are also possible. As is known in the art, the K-factor of a sprinkler is defined as K=Q/P^{1/2}, where Q represents the flow rate (in gallons/min GPM) of water from the outlet of the internal passage through the sprinkler body and P represents the pressure (in pounds per square inch (psi.)) of water or firefighting fluid fed into the inlet end of the internal passageway through the sprinkler body. Accordingly, the designed performance of a sprinkler is a function of the supply of a minimum fluid pressure or flow.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A protected branch connector assembly for a supply pipe of a fire protection device, the protected branch connector assembly comprising:
a tubular member having a first terminal end surface defining an inlet opening, a second terminal end surface defining an outlet opening, the second terminal end surface axially spaced from the first terminal end surface to define an internal passageway extending from the inlet opening to the outlet opening along a central longitudinal axis with an internal seal chamber formed between the inlet and outlet openings;
an annular seal member disposed within the internal seal chamber and defining a seated orientation circumscribed about the central longitudinal axis, the seal member having a first confronting surface confronting the inlet opening and a second confronting surface opposite the first confronting surface and confronting the outlet opening; and
a protective device including:
a plug body having a first end and a second end coaxially spaced apart from one another along a central body axis, the plug body being coaxially inserted into the outlet opening of the tubular member with the second end in surface contact with the second confronting surface of the seal member; and
at least one indicator to define at least one indicative relationship between the protective device and the tubular member that indicates the annular seal member is within the internal chamber in the seated orientation.

2. The assembly of claim 1, wherein the plug body includes a base centered about the central body axis defining the second end with a peripheral wall circumscribed about the base and the central body axis, the peripheral wall having an edge circumscribed about the central body axis to form the first end as an open end of the plug body, the edge defining a first indicator of the open first end of the plug body and a first indicative relationship between the protective device and the tubular member.

3. The assembly of claim 2, wherein the peripheral wall includes at least one slit between the edge of the peripheral wall and the base.

4. The assembly of claim 2, wherein the at least one indicator includes a first portion of the first end of the body extending radially with respect to the central body axis from the edge and a second portion circumscribed about the central body axis, the second portion being integrally connected with the first portion.

5. The assembly of claim 4, wherein the first portion includes a pair of diametrically opposed radially extending segments, at least one segment in the pair of segments being integrally connected with the second portion.

6. The assembly of claim 5, wherein the second portion is an annular ring.

7. The assembly of claim 4, wherein the second portion of the at least one indicator is in surface contact with the second terminal end surface of the tubular member defining a second indicative relationship between the protective device and the tubular member that indicates the annular seal member is within the internal chamber in the seated orientation.

8. The assembly of claim 4, wherein the second portion of the at least one indicator is spaced from the second terminal end surface of the tubular member defining a gap therebetween and a second indicative relationship between the protective device and the tubular member indicating that the annular seal member is within the internal chamber in the seated orientation.

9. The assembly of claim 1, wherein the at least one indicator includes a portion of the device coupled to the first end of the plug body and axially spaced from the second terminal end surface of the tubular member to define a gap therebetween and an indicative relationship between the protective device and the tubular member that indicates the annular seal member is within the internal chamber in the seated orientation.

10. The assembly of claim 9, wherein the at least one indicator includes a first segment extending axially from the first end of the plug body parallel to the central body axis; a second segment extending orthogonally with respect to the first portion of the indicator and radially with respect to the central body axis, the gap being between the second segment and the second terminal end surface of the tubular member.

11. The assembly of claim 10, wherein the at least one indicator includes a third segment extending orthogonally from the second segment in a direction parallel to the central body axis from the first end toward the second end of the protective device, the first and second segments of the at least one indicator defining a hinge connection between the third segment and the plug body, the indicator forming a lever for removal of the protective device from the tubular member.

12. The assembly of claim 11, wherein the third segment defines an annular ring having a central axis extending perpendicular to the central device axis when the second end is in surface contact with the second confronting surface of the seal member.

13. The assembly of claim 10, wherein the at least one indicator includes an annular ring affixed to the second segment and circumscribed about the central body axis and axially spaced from the second terminal end surface of the tubular member, the first and second segments of the at least one indicator defining a hinge connection between the annular ring and the plug body, the at least one indicator forming a lever for removal of the protective device from the tubular member.

14. The assembly of claim 13, wherein the at least one indicator includes a pair of indicators diametrically opposed from one another about the plug body, the annular ring being affixed to the second portion of each of indicators in the pair of diametrically opposed indicators.

15. The assembly of claim 14, wherein the annular ring includes a peripheral lever extending radially from the annular ring and aligned with the at least one indicator.

16. The assembly of claim 13, wherein the annular ring defines a first width about the central longitudinal axis, the second terminal end surface defining a second width about the central longitudinal axis, the first width being greater than the second width.

17. The assembly of claim 1, wherein the internal passageway includes an internal thread proximate the outlet opening with the plug body in a frictional fit with the internal thread to retain the device within the internal passageway with the second end of the plug body in surface contact with the second confronting surface of the seal member.

18. The assembly of claim 1, wherein the annular seal member including an internal surface between the first confronting surface, the second end of the plug body in a frictional fit with the internal surface to retain the device within the internal passageway and the plug body radially spaced from the internal passageway of the tubular member to define an indicative relationship between the protective device in which the protective device is freely releasable from the tubular member indicating an absence of the annular seal member within the internal chamber in the seated orientation.

19. A method of protecting a fire protection pipe assembly, the method comprising:
inserting a protective device into an outlet opening of a branch connector of the fire protection pipe assembly; and
indicating an internal seal member is in a seated orientation within an internal seal chamber of the branch connector with a dimensional relationship between the protective device and the branch connector.

20. The method of claim 19, wherein the inserting includes forming a surface contact engagement between a plug body of the device and the internal seal member, and wherein the indicating includes forming a gap between an indicator of the protective device and the branch connector by the surface contact engagement, the gap being the dimensional relationship.

21. The method of claim 20, wherein forming the gap includes locating the indicator at axial spaced distance from a terminal end face of the branch connector defining the outlet opening.

22. The method of claim 21, wherein the indicating includes locating an edge of the plug body flush with the outlet opening.

23. The method of claim 20, wherein the inserting includes locating an insertion end of the plug body in surface engagement with the internal seal member, and wherein the indicating includes locating a trailing end of the plug body opposite the insertion end and flush with the outlet opening of the branch connector.

24. The method of claim 19, wherein the inserting includes forming a surface contact engagement between a plug body of the protective device and the seal member, and wherein the indicating includes forming a surface contact between an indicator of the protective device and an end surface of the branch connector to define the dimensional relationship between the protective device and the branch connector.

25. The method of claim 24, wherein the inserting includes retaining the protective device within the branch connector by a frictional engagement consisting of the surface contact engagement between the plug body and the seal member.

26. A method of protecting a fire protection pipe assembly, the method comprising:
inserting a protective device into an outlet opening of a branch connector of the fire protection pipe assembly; and
indicating an internal seal member is missing from an internal seal chamber of the branch connector with an unretained engagement between the protective device and the branch connector.

27. The method of claim 26, wherein the indicating includes releasing the protective device from the branch connector and out of the outlet opening under a force of gravity.

28. A protection device for a fire protection pipe fitting:
a body including an insertion edge circumscribed about a central axis and a trailing edge circumscribed about the central axis, the insertion edge and trailing edge being axially spaced apart from one another; and
an indicator affixed to the trailing edge and at least one of: (i) axially spaced from the trailing edge; or (ii) circumscribed about the trailing edge.

29. The device of claim 28, wherein the body includes a base centered about the central axis defining the insertion edge with a peripheral wall circumscribed about the base and the central axis, the peripheral wall having an edge circumscribed about the central axis and spaced from the central axis to define the trailing edge being an open end of the body.

30. The device of claim 29, wherein the peripheral wall includes at least one slit between the edge of the peripheral wall and the base.

31. The device of claim 28, wherein the indicator includes a first segment extending axially parallel to the central axis, the indicator includes a second segment extending orthogonally with respect to the first segment.

32. The device of claim 31, wherein the indicator includes a third segment extending orthogonally from the second segment in a direction parallel to the central axis from the trailing edge toward the insertion edge of the body, the first and second segment of the at least one indicator defining a hinge connection between the third segment and the body to form a lever.

33. The device of claim 32, wherein the third segment defines an annular ring.

34. The device of claim 31, wherein the at least one indicator includes an annular ring affixed to the second segment of the indicator and circumscribed about the central axis.

35. The device of claim 34, wherein the device includes a pair of indicators diametrically opposed indicators from one another about the body, the annular ring being affixed to each indicator in the pair of diametrically opposed indicators.
